(19) United States
(12) Patent Application Publication
(10) Pub. No.: US 2005/0287339 A1
(43) Pub. Date: Dec. 29, 2005

(54) Weatherseal having surface roughness forming particles of a polar material in a resin matrix having a maleated polyolefin

(75) Inventor: Matthew J. Leatherman, Rockford, TN (US)

Correspondence Address: Stephen B. Salai, Esq.;Harter, Secrest & Emery LLP, 1600 Bausch & Lomb Place, Rochester, NY, 14604-2711, US

(73) Assignee: Schlegel Corporation, New York, NY (US)

(21) Appl. No.: 10/877,660

(22) Filed: Jun. 25, 2004

(51) Int. Cl. B32B 1/00

(52) U.S. Cl. 428/143

(57) ABSTRACT

A vehicular weatherseal is provided having a particulated matrix formed of resin matrix including a maleated polyolefin and a plurality of surface roughness forming particles bonded to the resin matrix, wherein the particles are formed of a polar material, such as polysulfone, nylon, and polyester. The maleated polyolefin resin matrix and surface roughness forming particles can be mixed and extruded onto a weatherseal body or substrate.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to vehicular weatherseals and, more particularly, to a resin matrix having a maleated polyolefin for retaining a plurality of surface roughness forming particles, wherein the particles are formed of a polar material.

2. Description of Related Art

Many vehicles employ windows formed of glass panels, wherein the window can be fixed or moveable relative to the vehicle. A common construction includes the use of a glass panel in a door, wherein the door and the glass panel move relative to the remainder of the vehicle, and the glass panel moves relative to the door. In this construction, the glass panel is frequently moved between an open position and closed position with respect to the door and/or a portion of the vehicle frame. Increased business transactions such as restaurant, banking and pharmacy services are now regularly offered in a drive-through format. These transactions require the repeated release and engagement of the glass panel and the vehicle. The repeated opening and closing of the glass panel places significant stress on the seal between the glass panel and the vehicle.

Weatherseals are also employed at the interface of a fixed panel such as a front or rear window and the adjacent portion of the vehicle body.

The weatherseal must substantially preclude the penetration of water, airborne particles and air along the periphery of the glass panel, while for moveable windows still permit ready engagement and disengagement of the glass panel without requiring excessive force.

Therefore, the need exists for a weatherseal that provides reduced friction when engaging and disengaging a panel. The need also exists for a weatherseal that can guide the travel of a panel relative to the weatherseal, while maintaining a reduced sliding friction. The need further exists for a weatherseal that can satisfy sliding force cycle tests without requiring relatively expensive materials.

### BRIEF SUMMARY OF THE INVENTION

The present invention provides a weatherseal for repeatedly releasably contacting a panel, wherein the weatherseal has a reduced coefficient of friction between the weatherseal and the panel, while providing enhanced sealing characteristics. The weatherseal of the present invention also provides enhanced durability in terms of engagement/disengagement cycles.

The present weatherseal provides a compatibility between surface roughness forming particles and a resin matrix, which were previously incompatible. More specifically, the present weatherseal overcomes an incompatibility between polar material particles and a matrix formed of a nonpolar material. In one configuration, the resin matrix includes a maleated polyolefin to effectively bond with particles of a polar material such as polysulfone, polyamide, and polyester.

Thus, the present invention contemplates a vehicular weatherseal having a resin matrix including a maleated polyolefin and a plurality of surface roughness forming particles bonded to the resin matrix, the particles being formed of a polar material such as polysulfone, nylon, and polyester. This combination of particles and resin matrix allows use of a traditionally non polar substrate, such as a weatherseal body, in conjunction with particles of a polar material, wherein the particles have an enhanced resistance to heat and wear. Specifically, the incorporation of a maleated polyolefin in the resin matrix maintains a bonding to a non polar material of the weatherseal body, as well as providing bonding to the polar material of the particles.

As the matrix is preferably formed to be at least substantially solvent-free, the weatherseal can be formed in an extrusion process, without requiring the secondary steps normally associated with solvent-based resins, such as driving off or removing solvents. That is, the maleated polyolefin matrix has a high solid content, which is sufficiently high to allow extrusion of the matrix.

### BRIEF DESCRIPTION OF THE SEVERAL VIEWS OF THE DRAWING(S)

FIG. 1 is a perspective view of a vehicle employing a number of weatherseals.

FIG. 2 is a perspective view of a weatherseal incorporating the present weatherseal.

FIG. 3 is a cross-sectional view showing a relationship between a panel and a weatherseal.

FIG. 4 is a perspective view of a further configuration of the weatherseal.

FIG. 5 is a perspective view of an alternative configuration of the weatherseal.

FIG. 6 is a perspective view of another configuration of the weatherseal.

FIG. 7 is a schematic cross sectional view showing representative polar surface roughness forming particles in a maleated matrix.

### DETAILED DESCRIPTION OF THE INVENTION

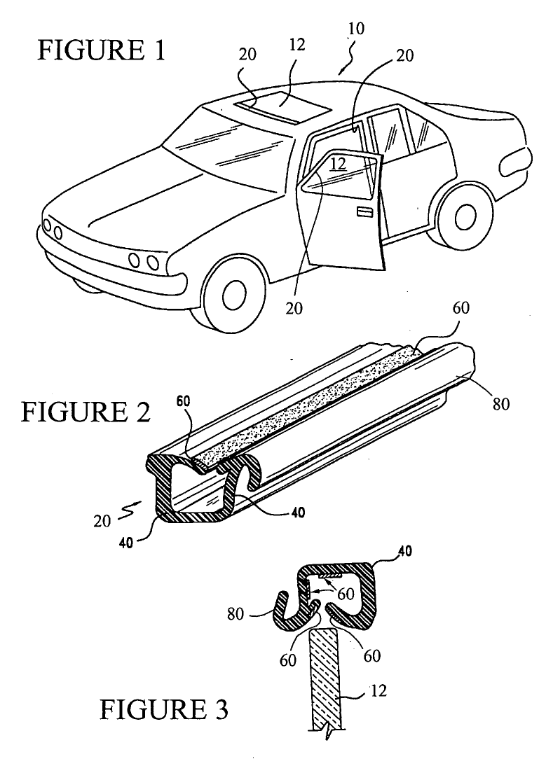

Referring to FIG. 1, the present weatherseal 20 is employed in a vehicle 10 so as to be operably located between a panel 12 and a portion of the vehicle. The engagement of the panel 12 and the weatherseal 20 can result from motion of the panel, the weatherseal or a combination of both. Generally, the weatherseal 20 is disposed between the glass panel and a door, a frame of the door, or a portion of the vehicle frame.

The term “weatherseal” includes, but is not limited to, extrusions, moldings, trim, trim pieces, edge pieces, glass guidance components, glass run channels, weatherseals and seals. In the motor vehicle industry, a weatherseal configuration of the present invention is suitable for use in many areas including, but not limited to, glass guidance components, glass run channels, door seals, roof rails, deck lids, hood-to-cowl seals, window seals, sun roof seals or inner and outer belt line seals. In particular, the present invention finds application in glass run channels.

It is understood the panel 12 can be any of a variety of materials and does not limit the present invention. For example, the panel 12 can be glass, metal or a composite, which is painted, surface treated or bare. In the operating environment, the panel 12 is brought repeatedly into and out of engagement with the weatherseal 20. The engagement of the panel 12 and the weatherseal 20 can result from motion of the panel relative to the weatherseal. Alternatively, the weatherseal 20 can be moved relative to the panel 12.

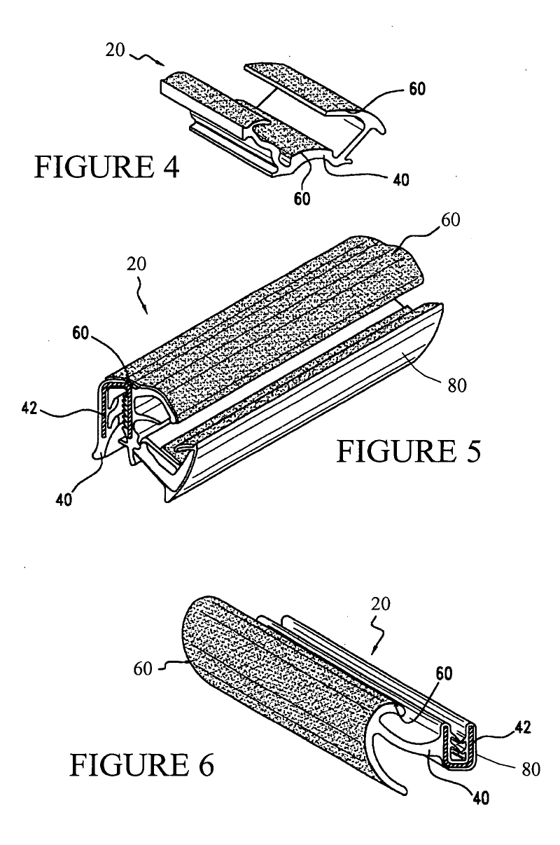

As seen in FIGS. 2-6, the weatherseal 20 includes a substrate 40 and a particulated matrix 60, wherein the particulated matrix contacts the panel 12, as shown in FIG. 3, either during motion of the panel relative to the weatherseal or in a seated position of the panel. It is understood that the particulated matrix 60 can be located on only a portion of the substrate 40.

Substrate

The substrate 40 forms a base or body, such as a weatherseal body, to which the particulated matrix 60 is connected. The substrate 40 can be formed of a variety of materials including thermoplastic or thermosetting materials including, but not limited to, TPE, EPDM or any combination thereof. Satisfactory thermoplastic and TPE materials include Sarlink® by DSM Thermoplastic Elastomers, Inc. of Massachusetts; Santoprene® by Advanced Elastomer Systems of Ohio and Uniprene® by Teknor Apex Company of Rhode Island. Suitable vulcanized or cross-linked (thermosetting) polymeric materials include EPDM, EPDM modified with chlorobutyl, and EPDM-SBR blends. The substrate 40 has a durometer of approximately 50 to 80 Shore A, with a preferred hardness of approximately 70 to 75 Shore A.

These substrate materials are effectively non polar, thereby historically precluding sufficient bonding to particles of a polar material. That is, while these substrate materials bond to a non maleated polypropylene matrix, such matrix does not bond to, or retain particles of a polar material such as formed of a polar material such as polysulfone. Thus, the advantageous characteristics of particles of these materials have been unavailable in combination with the weatherseal body of a non polar material.

The substrate 40 can have a relatively rigid portion and a relative soft portion. That is, the substrate 40 can exhibit dual durometer characteristics. Referring to FIGS. 5 and 6, the substrate 40 can include a reinforcing member 42 such as a wire or metal carrier, which may be of known construction (e.g. knitted wire, slotted or stamped metal). It is contemplated the substrate 40 can also include a thermoplastic portion and a thermoset portion each having a unique rigidity, wherein the thermoplastic portion typically increases the rigidity of the weatherstrip 10. In addition, the substrate 40 can be formed of differing thickness to provide differing amounts of rigidity. The substrate 40 can have any of a variety of cross sections. For example, the cross-section profile can be generally “U”-shaped, “J”-shaped, “L”-shaped or planar. Referring to FIGS. 2, 3, 5 and 6, the substrate can include an exterior or trim portion 80 which does not contact the panel 10.

Particulated Matrix

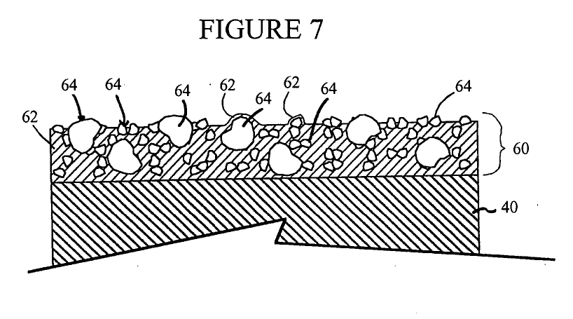

The particulated matrix 60 is disposed on the substrate 40. The particulated matrix 60 forms a contact surface for contacting the panel 12. As seen in FIG. 7, the particulated matrix 60 is formed from a resin matrix 62 and a multitude of particles 64, thereby forming a particulated contact surface. Referring to FIG. 7, the plurality of particles 64 form at least a portion of the contact surface.

The resin matrix 62 includes a maleated polyolefin. Preferred maleated polyolefins include maleated polypropylene, maleated polyethylene, maleated thermoplastic vulcanizate/thermoplastic olefin, or maleated ethylene propylene rubber, including maleated ethylene propylene diene monomer (EPDM). A satisfactory resin matrix 62 has been found to be a maleated EPDM, such as the maleic anhydride grafted EPDM marketed under the trademark Royaltuf® as sold by Crompton Corporation.

The resin matrix 62 includes at least a percentage of maleated polyolefin. While the resin matrix 62 can be formed entirely of maleated polyolefin, as the maleated polyolefin is typically more expensive than the non-maleated polyolefin, the resin matrix can be a blend of maleated polyolefin and non-maleated polyolefin. The percentage, or portion, of maleated polyolefin is selected to be sufficient to bond the selected particles 64 in the resin matrix 62. The resin matrix 62 has at least 1% by weight maleated polyolefin and can have up to 100% by weight maleated polyolefin. A composition could include approximately 0% to 95% nonpolar polyolefin, approximately 100% to 1% maleated polyolefin and approximately 1% to 30% by weight particles of a polar material. More particularly, the composition can be approximately 50% by weight non-maleated propylene, approximately 40% by weight maleated polypropylene and approximately 10% by weight particles 64 formed of the polar material to form the particulated matrix 60. An alternative composition of the matrix 60 includes approximately 50% by weight non-maleated polypropylene, approximately 40% by weight maleated EPDM and approximately 10% by weight particles 64 formed of the polar material. Such matrix compositions can be readily extruded.

It is understood that fillers, binders or other additives can be included in the resin matrix 62. While the resin matrix 62 is preferably selected to bond to the substrate 40 and the particles 64 without requiring secondary adhesives, it is understood that secondary adhesives, such as for example urethane, can be used in connection with the particulated matrix 60.

The resin matrix 62 is preferably solvent-free and thus lends itself to advantageous manufacturing processes including extrusion. By “solvent-free”, the resin matrix 62 has a high solids content, preferably at least approximately 99% solids and more preferably approximately 100% solids.

The particles 64 can be formed of a polar material such as polysulfone, polyamide (nylon), and polyester. Particles of these materials exhibit an enhanced resistance to wear and heat compared to non polar particles of the prior art. Preferably, the particles 64 are non-degrading to the panel 12. It is understood the particles 64 can be formed of different materials. That is, a first portion of the plurality of particles 64 can be a first one of the polar materials and a second portion of the plurality of particles can be a different second polar material.

The particles 64 are selected and sized to provide a sufficient roughness to reduce friction between the weatherseal 20 and the panel 12 without sacrificing the desired sealing function. That is, the weatherseal 20 substantially precludes environmental migration, such as water or air leaks, across the panel-weatherseal interface under intended operating parameters.

Generally referring to FIG. 7, the particles 64 can be uniformly distributed throughout the resin matrix 62 and hence particulated matrix 60. Alternatively, the particles 64 can be located proximal to the surface of the resin matrix 62. The contact surface is thus defined by a plurality of surface projections extending from the resin matrix 62. The surface projections generally define the contact area between the weatherseal 20 and the panel 12.

The surface projections can have a density of approximately 1 to 5 projections per square millimeter. Typically, the surface projections extend from an adjacent portion of the coating by a distance of approximately 5 to 125 microns. It is understood that design considerations can require alternative sized projections, and hence particles 64.

Referring to FIG. 7, the surface projections can be formed as the particles 64 are encapsulated by the resin matrix 62. That is, a convex bulge in the resin 62 is formed by an underlying particle 64. Alternatively, the projection can be formed by an exposed surface of the particle 64. That is, the particle 64 is partially embedded in the resin 62 and a portion of the particle is exposed as a surface projection. Further, the particle 64 can effectively lie atop of the resin matrix 62, wherein substantially the entire particle defines the projection.

The relative high points defined by the projections provide a reduced surface area in contact with the panel 12. The projections are sufficiently sized and spaced to maintain a seal between the weatherseal 20 and the panel 12. The reduced area of contact created by the particle results in a reduced static and dynamic coefficient of friction between the weatherseal 20 and the panel 12. In addition, sliding friction is reduced by the present configuration.

The inclusion of the maleated polyolefin in the resin matrix 62 is selected to bond the polar particles 64 to the resin matrix, as well as maintain the bonding of resin matrix to the non polar material of the substrate 40. It has been found that by modifying the resin matrix 62 with a maleated polyolefin, the polar material of the particles 64 bonds to the matrix and hence to the substrate 40 which in turn is formed of an economical, readily processed and weather resistant non polar material. The resin matrix 62 incorporating the maleated polyolefin will bond to the particles 64 and the substrate 40, as opposed to the non-maleated polyolefin which typically only bonds to the substrate. Therefore, the present invention allows the use of particles formed of a polar material (which exhibits an enhanced wear and heat resistance) with a weatherseal body formed of a nonpolar material, by virtue of the resin matrix 62 including a percentage of maleated polyolefin sufficient to bond and retain the particles 64.

Typically, the particles 64 will have a size between approximately 20 microns to 200 microns, with a preferred range of approximately 35 microns to 120 microns, and a more preferred range of approximately 35 microns to 65 microns. The particle size can be selected in conjunction with the desired thickness of the particulated matrix 60. In addition, as seen in FIG. 7, the particles 64 can be of different or varying sizes.

The particulated matrix 60 can have any of a variety of thicknesses, as dictated by the intended operating environment of the weatherseal 20. For example, the matrix can be from approximately 10 microns to approximately 1,000 microns.

Method of Manufacture

The substrate 40 can be formed by any of a variety of conventional manufacturing methods. Extrusion, molding and forming are all known methods of producing the substrate 40, with or without the reinforcing member 42.

The particulated matrix 60 can be applied to the substrate 40 simultaneously with the formation of the substrate or subsequent to the formation of the substrate.

The particles 64 can be introduced into the resin matrix 62 before application to the substrate 40, or after formation of the substrate. That is, the particles 64 can be introduced into the resin matrix 62 after application of the matrix to the body, by any of a variety of deposition methods such as spreaders, sprayers or rollers. Thus, the particulated matrix 60 can include particles 64 which are spread, sprayed or rolled onto or into the resin matrix 62. In one construction, the body 40 is formed by extrusion, the resin matrix 62 is extruded onto the body and the particles 64 subsequently imparted to the matrix.

Alternatively, the resin matrix 62 and the particles 64 are mixed together and extruded together onto a surface of the substrate 40 to form the particulated matrix 60. The resin matrix 62 and particles 64 can be extruded, co-extruded or simultaneously extruded with the substrate 40.

While a preferred embodiment of the invention has been shown and described with particularity, it will be appreciated that various changes and modifications may suggest themselves to one having ordinary skill in the art upon being apprised of the present invention. It is intended to encompass all such changes and modifications as fall within the scope and spirit of the appended claims.

1. A vehicular weatherseal, comprising:
(a) a resin matrix including a maleated polyolefin; and
(b) a plurality of surface roughness forming particles bonded to the resin matrix, the particles being formed of a polar material.

2. The vehicular weatherseal of claim 1, wherein the particles are one of polysulfone, nylon, and polyester.

3. The vehicular weatherseal of claim 1, further comprising a substrate connected to the resin matrix, the substrate being one of a thermoset and a thermoplastic.

4. The vehicular weatherseal of claim 3, wherein the thermoset includes an EPDM.

5. The vehicular weatherseal of claim 3, wherein the substrate has a cellular structure.

6. The vehicular weatherseal of claim 1, wherein the resin matrix is solvent-free.

7. The vehicular weatherseal of claim 1, wherein the resin matrix is approximately 99% solids.

8. The vehicular weatherseal of claim 1, wherein the resin matrix is extrudable.

9. The vehicular weatherseal of claim 1, wherein the particles are located to releasably engage a vehicular panel moveable relative to the resin matrix.

10. The vehicular weatherseal of claim 1, wherein the maleated polyolefin is selected from a group consisting of maleated polypropylene, maleated polyethylene, maleated thermoplastic vulcanizate/thermoplastic olefin, or maleated ethylene propylene rubber.

11. The vehicular weatherseal of claim 1, wherein the resin matrix includes from approximately 1% to 100% maleated polyolefin.

12. The vehicular weatherseal of claim 1, wherein the resin matrix includes from approximately 1% to 100% maleated polypropylene.

13. The vehicular weatherseal of claim 1, wherein the resin matrix includes from approximately 1% to 100% maleated polyethylene.

14. The vehicular weatherseal of claim 1, wherein the resin matrix includes from approximately 1% to 100% maleated EPDM.

15. The vehicular weatherseal of claim 1, wherein the resin matrix includes maleated polyolefin and non maleated polyolefin.

16. The vehicular weatherseal of claim 1, wherein the particles have a size between approximately 20 microns to approximately 200 microns.

17. A method of forming a surface for a vehicular weatherseal, the method comprising:
(a) forming a resin matrix including a maleated polyolefin; and
(b) introducing a plurality of surface roughness forming particles to the resin matrix, the particles formed of a polar material.

18. The method of claim 17, wherein introducing the plurality of surface roughness forming particles to the resin matrix includes mixing the plurality of surface roughness forming particles with the resin matrix.

19. The method of claim 17, wherein introducing the plurality of surface roughness forming particles to the resin matrix includes embedding the plurality of surface roughness forming particles into the resin matrix.

20. The method of claim 17, wherein introducing the plurality of surface roughness forming particles to the resin matrix includes extruding the plurality of surface roughness forming particles with the resin matrix.

21. The method of claim 17, wherein introducing the plurality of surface roughness forming particles to the resin matrix includes coextruding the plurality of surface roughness forming particles with the resin matrix.

22. The method of claim 17, wherein introducing the plurality of surface roughness forming particles to the resin matrix includes simultaneously extruding the plurality of surface roughness forming particles with the resin matrix.

23. The method of claim 17, further comprising introducing the plurality of surface roughness forming particles to the resin matrix after an extrusion of the resin matrix.

24. The method of claim 17, further comprising introducing the plurality of surface roughness forming particles to the resin matrix before an extrusion of the resin matrix.

25. The method of claim 17, further comprising including maleated polypropylene as the maleated polyolefin.

26. The method of claim 17, further comprising including maleated polyethylene as the maleated polyolefin.

27. The method of claim 17, further comprising including non maleated polyolefin in the resin matrix.

28. The method of claim 17, further comprising sizing the particles to be between approximately 20 microns and 200 microns.

29. The method of claim 17, further comprising including maleated EPDM as the maleated polyolefin.

30. The method as in one of claims 17-29, further comprising forming the particles from at least one of polysulfone, nylon, and polyester.

31. The method as in one of claims 17-29 further comprising forming the resin matrix to be substantially solvent-free.

32. The method as in one of claims 17-29, further comprising forming the resin matrix to be at least approximately 99% solids.

33. The method as in one of claims 17-29, further comprising forming the resin matrix on a substrate.

34. The method as in one of claims 17-29, further comprising extruding the resin matrix on a substrate.

35. The method as in one of claims 17-29, further comprising coextruding the resin matrix with a substrate.

36. The method as in one of claims 17-29, further comprising simultaneously extruding the resin matrix with a substrate.

37. The method as in one of claims 17-29, further comprising bonding the resin matrix to a substrate.

38. The method as in one of claims 17-29, wherein embedding the particles includes impacting the resin matrix with the particles.
